(19) United States
(12) Patent Application Publication
(10) Pub. No.: US 2015/0175240 A1
(43) Pub. Date: Jun. 25, 2015

(54) MUSCLE-PROPELLED VEHICLE

(71) Applicant: Stefano MANGINI, Nole (TO) (IT)

(72) Inventor: Stefano Mangini, Nole (IT)

(21) Appl. No.: 14/416,472

(22) PCT Filed: Jul. 22, 2013
(86) PCT No.: PCT/IB2013/001605

§ 371 Date: Jan. 22, 2015

(30) Foreign Application Priority Data
Jul. 23, 2012 (IT) MI2012A001278

(51) Int. Cl. B62M 1/12; B62M 3/14; B62M 3/06; B62K 19/00; B62M 15/00; B62K 3/02; B62K 21/02; B62K 21/12; B62M 3/08; B62M 23/00

(52) U.S. Cl. CPC B62M 1/12; B62M 3/08; B62M 3/14; B62M 3/06; B62M 23/00; B62M 15/00; B62K 3/02; B62K 21/02; B62K 21/12; B62K 19/00; B62M 2009/005

(57) ABSTRACT

The present invention relates to a muscle-propelled vehicle with two or more wheels, more particularly a vehicle with front drive and steering. The vehicle of the present invention is designed to exploit the propulsive force exerted by the rider by the lower and the upper limbs, however without imposing the rotary movement of feet and hands to perform the rotary motion to be transmitted to the driving wheel. The vehicle according to the present invention comprises a frame, at least one rear wheel mounted idle on a rear fork of said frame, at least one front wheel mounted on a front fork, in turn so mounted as to be steering relative to the frame, a transformation mechanism of the muscle-propelled motion into a rotary motion, and a transmission mechanism of said rotary motion to said at least one front wheel, wherein said transformation mechanism comprises a pair of cranks rotatably integral with said transmission mechanism, and said mechanism also comprises at least two pairs of connecting rods, that are driven by the four limbs of the rider.

The present invention relates to a muscle-propelled vehicle with two or more wheels, more particularly a vehicle with front drive and steering. As the versions with more wheels are structurally similar to a two wheel embodiment, the following description will refer only to the latter, but for mentioning the difference where needed.

The vehicle of the present invention is configured so as to exploit the propulsion force exerted by the rider through both the upper and lower limbs, however without involving a rotary motion of hands and feet to achieve the rotary motion to be transmitted to the traction wheel.

In the traditional two-wheeled vehicles such as the bicycle, propulsion is achieved by the thrust of foot on pedal and from pedal to crank, which drags the crown wheel; in the circular motion of the crank, the foot thrust works positively only for a straight angle, i.e. from the uppermost to the lowermost point of the circular path. Therefore the foot thrust tends to contribute actively to the propulsion only for half crank stroke, with a defined unchangeable stroke and efficiency in the development of the muscle power constrained by said stroke.

In order to remove this drawback, propulsion systems were developed and are known from the prior art, where the foot thrust is no more exerted directly on the crank, but on a connecting rod which is connected with the crank at one end, while the other end is sliding on generally straight guides fixed to the frame.

The foot is making a motion associated to the connecting rod. Therefore, correctly studying the proportions of the mechanism and its alignment relative to the final transmission, it is possible to obtain a motion of the connecting rod comparable with the man's gait or anyway a more natural motion for the rider. This increases the foot working stroke, optimising the propulsion power of the lower limbs.

However the vehicles adopting propulsion systems of the above described kind, besides having a considerable size with regard to the wheel base, more particularly due to the longitudinal development of the propulsion system, do not allow to achieve a comfortable sitting for the rider or a sitting place is even missing. For instance there are vehicles with two driving wheels, as disclosed in U.S. Pat. No. 4,548,420, allowing a good motion system, but needing two transmission systems, while no co-ordination of front and rear movements is possible. Said vehicle is not suitable for variable attitude operation and more or less reclined positions cannot be taken by the user. The power generated by such a vehicle thus does not appear to be considerable. Another example of a muscle-propelled vehicle with two or more wheels is disclosed in US 2011/278814, more particularly designed for transportation of a person, but it cannot be used as a training device nor for high performances. Such a vehicle is good to be carried, but it is not adapted to be operated with (thus to train) all the four limbs and moreover it has a fixed attitude.

A further example of the variety of developed muscle-propelled vehicles, is for instance disclosed in DE 10310659, illustrating a vehicle suitable both for training and walking purposes, comprising at least three wheels, and having a necessarily long wheel base in view of the lever length. The disclosed vehicle is suitable for physical exercise, which is also one object of the invention described hereinafter. However, it has to be pointed out that the vehicle disclosed in this prior art disclosure, for structural limitations cannot be provided with a seat, and has a limited number of possible configurations of use. There are no pedals in said vehicle, and this obliges to have a very long wheel base, to the detriment of the handling possibility. Even the steering possibility is very reduced, thus limiting again the handling and performances of the vehicle. Moreover said vehicle does not allow the maximum development of muscle power by the user in view of the absence of backrest, pedals and constraints for the limb movements. Finally, the vehicle has no variable attitude, and this limits considerably the possibility of a versatile use of the vehicle, thus reducing further the possible performances.

The vehicle described in the present invention intends to keep the characteristics of said existing vehicles but improving their performances, handling and versatility, with considerable advantages in respect of the disclosed propulsion systems, i.e. the naturalness of the motion and efficiency of the propulsion effort of the rider, as well as steering efficiency and applicable muscular exercise, while allowing also to reduce considerably the dimensions. In turn, reduction of dimensions leaves a great freedom in defining the final design of the vehicle, with particular reference to the frame and sitting of the rider.

These and other advantages are achieved mainly by adoption of a front driving wheel, this choice leading to a configuration in which the system consisting of connecting rod and crank is arranged on the front part of the vehicle, more particularly on the fork of the front wheel. Thus the problem existing in the prior art of the longitudinal dimensions of the vehicle is totally eliminated, and a variety of vehicle designs are therefore possible as a function of wheel base, forecarriage, seat location. Moreover it is possible to provide for vehicle frames that may be folded, when the vehicle is not operative and should be stored or put away, or in any case configured in such a way that wheel base and forecarriage may be easily modified. Finally the vehicle of the present invention may add handlebars connected either directly or through suitable intermediate members, with the propulsion system, with the clear consequence of increasing the rider's contribution to the vehicle propulsion.

The muscle-propelled vehicle according to the present invention, thanks to the high number of possible configurations of the motion paths of both lower and upper limbs, that ca be carried out by the propulsion system, may be adapted for use in therapeutic programs, in performing specific physical training and in a more general sense in the fitness exercises. For instance, through suitable supports allowing to keep the vehicle raised relative to the bearing plane, it will be possible to use the vehicle like a conventional cyclette; a suitable device may be added to or substituted for the front wheel, to which the propulsion motion is transmitted, said device being adapted to apply a possibly adjustable braking torque, similar to the devices already existing on the known gymnastic equipments. It is also to be noted that, in applications for physical exercise, said possibility of different configurations has a number of solutions even greater than those possible when using it as a transportation vehicle. More particularly between these solutions one can point out those in which the relative angle between the crank axes is different from 180° (which is the generally preferred and for many reasons preferable solution) but may be any desired angle, more particularly a null angle.

The main object of the present invention is to provide for a muscle-propelled vehicle with two or more wheels, having a system of transformation of the propulsion motion generated by both the lower and the upper limbs.

Another object of the present invention is to provide for a muscle-propelled vehicle with two or more wheels, having a system of transformation of the propulsion motion connected with a transmission system acting on the steering front wheel of the vehicle.

Still another object of the present invention is to provide for a muscle-propelled vehicle with two or more wheels, having a frame adapted to be inclined in an adjustable way relative to the fork of the rear wheel, so as to change the wheel base of the vehicle.

A further object of the present invention is to provide for a muscle-propelled vehicle with two or more wheels, having a frame adapted to be inclined in an adjustable way relative to the fork of the front wheel, in order to maintain a bearable forecarriage when changing the wheel base of the vehicle.

Still an object of the present invention is to provide for a muscle-propelled vehicle with two or more wheels, wherein the motion of the limbs may be developed in a more or less efficient way with a broad possibility of convolutions, not necessarily circular, which may be changed even sharply, without being obliged to change components, but changing even only the mutual position of the components.

A further object of the present invention is to provide for a muscle-propelled vehicle with two or more wheels, having a frame and a sitting member for the rider, which has a position that can be adjusted relative to the frame.

Finally an object of the present invention is to provide for a device for physical exercise, wherein the motion of the lower and upper limbs is carried out by a system of motion transformation very similar to that adopted for the above mentioned muscle-propelled vehicle.

A detailed description of preferred and alternative embodiments of the two-wheeled muscle-propelled vehicle according to the present invention will now be given, the versions with more wheels being fully analogous as to structure, with the only additional requirement that in case of more front wheels, the movement of the connecting rods induced by the guides must not intersect the front axle connecting said front wheels. The description will be given making reference to the accompanying sheets of drawings, where same reference numerals identify identical or similar elements, in which:

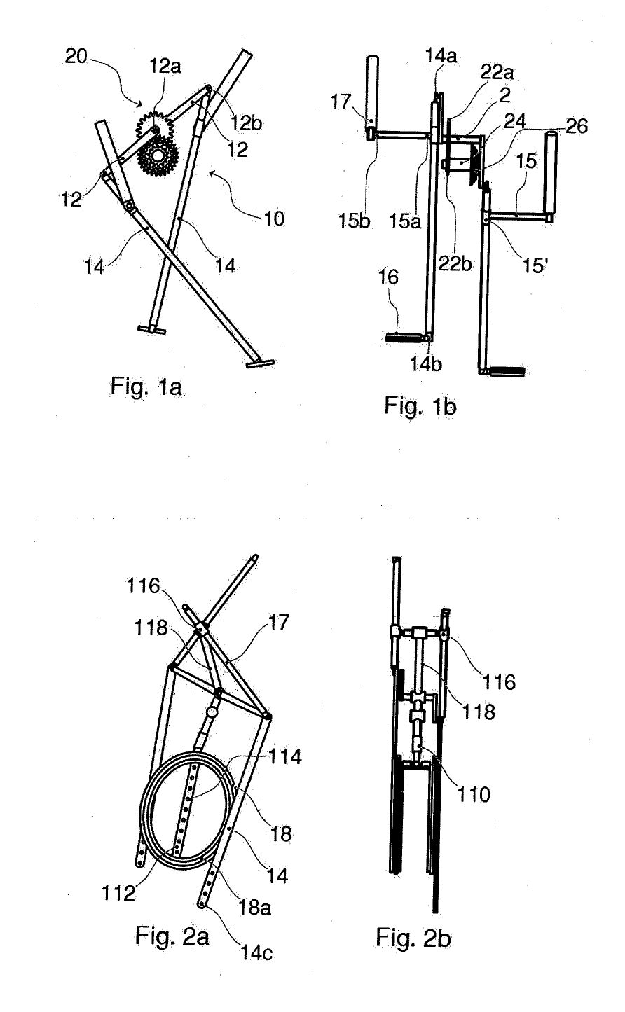

FIG. 1a is a side view of a portion of the mechanism of transformation of motion of the muscle-propelled vehicle according to a first embodiment of the present invention;

FIG. 1b is a front view of the embodiment shown in FIG. 1a;

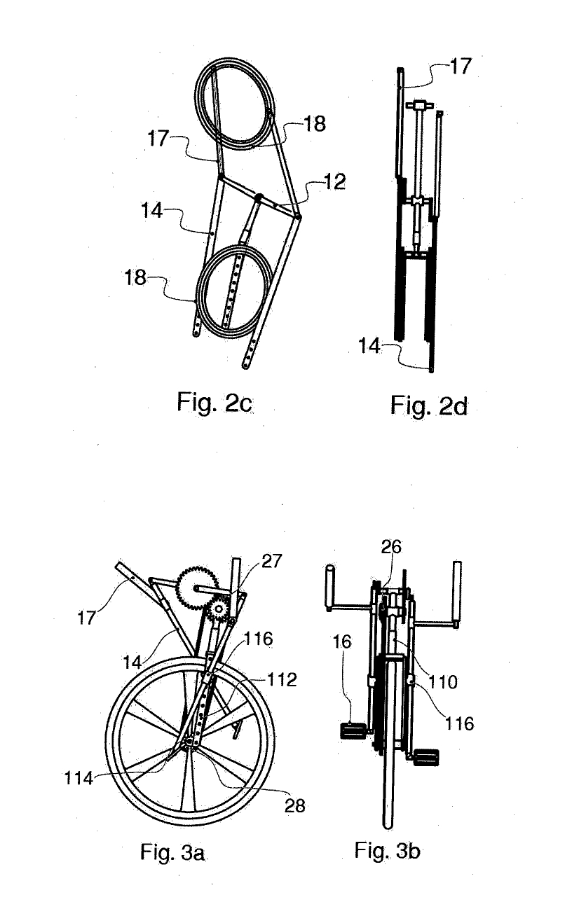

FIG. 2a is a side view of a mechanism of transformation of motion of the muscle-propelled vehicle according to a second embodiment of the present invention;

FIG. 2b is a front view of the embodiment shown in FIG. 2a;

FIG. 2c is a side view of the mechanism of transformation of motion of the muscle-propelled vehicle according to an alternative embodiment of the mechanism shown in FIGS. 2a and 2b.

FIG. 2d is a front view of the embodiment shown in FIG. 2c;

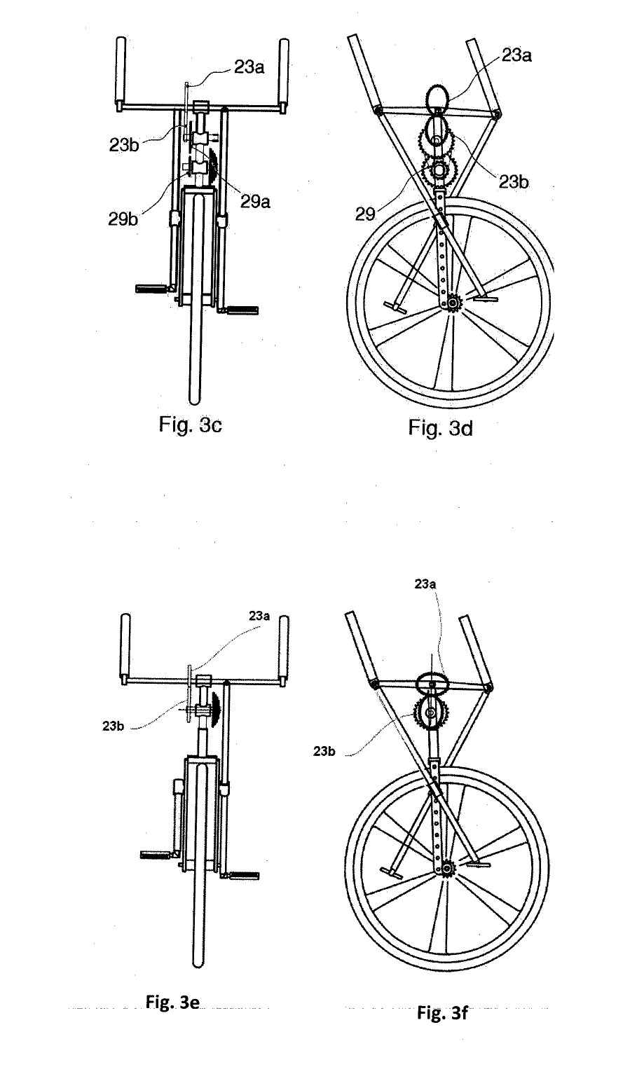

FIG. 3a is a front view of the mechanism of transformation of motion partially shown in FIGS. 1a and 1b and of a transmission mechanism of the vehicle according to an embodiment of the present invention;

FIG. 3b is a front view of the embodiment shown in FIG. 3a;

FIG. 3c is a front view of the motion transformation mechanism associated with an alternative mechanism of motion transmission according to a first assembling configuration;

FIG. 3d is a side view of the alternative embodiment of the motion transmission mechanism shown in FIG. 3c;

FIG. 3e is a front view of the mechanism of motion transformation associated to the motion transmission mechanism shown in FIG. 3c according a second assembling configuration;

FIG. 3f is a side view of the embodiment of the motion transmission mechanism shown in FIG. 3e;

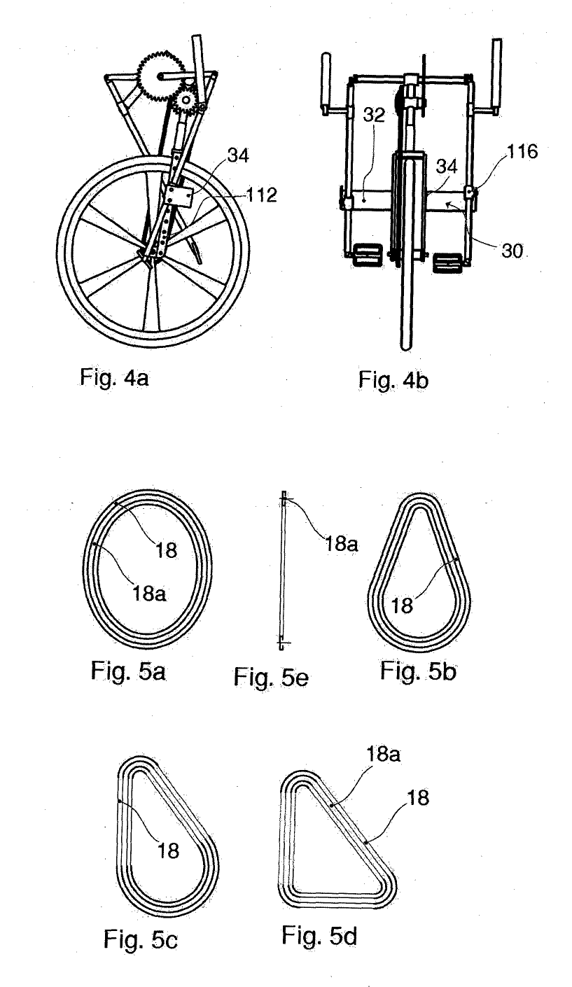

FIG. 4a is a side view of the motion transformation mechanism of the muscle-propelled vehicle according to a third embodiment of the present invention and of the transmission mechanism shown in FIGS. 3a and 3b;

FIG. 4b is a front view of the embodiment shown in FIG. 4a;

FIGS. 5a to 5d are side views of guide members for the motion transformation mechanism according to corresponding embodiments of the muscle-propelled vehicle of the present invention;

FIG. 5e is a sectional view of the guide member of FIG. 5a;

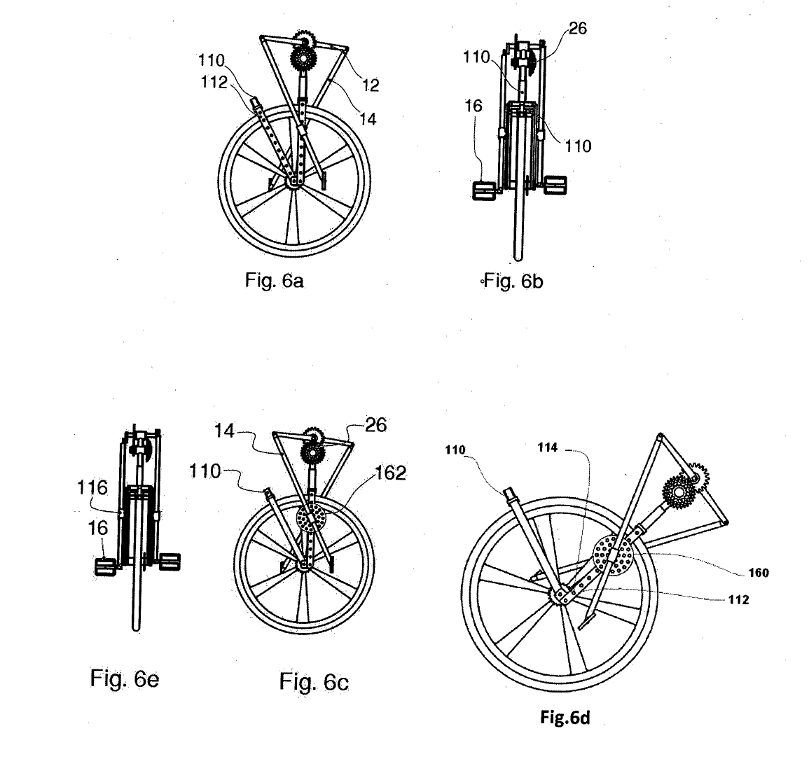

FIG. 6a is a side view of the motion transformation mechanism according to an alternative embodiment of the transformation mechanism shown in FIGS. 3a and 3b;

FIG. 6b is a front view of the embodiment shown in FIG. 6a;

FIG. 6c is a side view of the motion transformation mechanism according to an alternative embodiment of the motion transformation mechanism shown in FIGS. 6a and 6b, in its first configuration;

FIG. 6d is a side view of the motion transformation mechanism shown in FIG. 6c in its second configuration;

FIG. 6e is a front view of the motion transformation mechanism shown in FIGS. 6c and 6d;

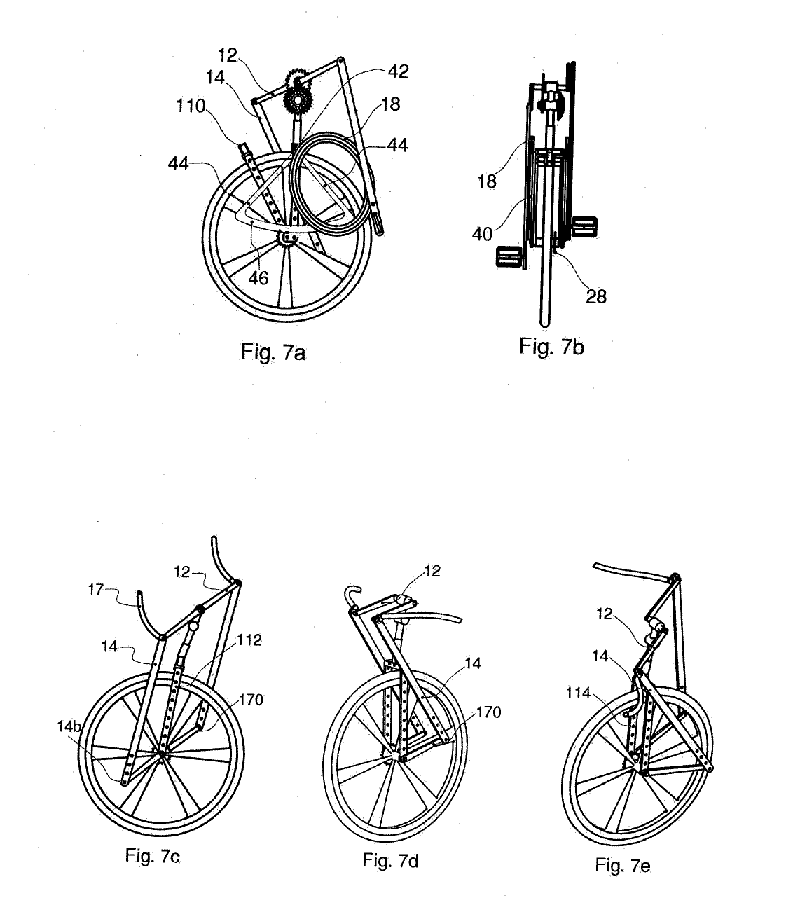

FIG. 7a is a side view of a motion transformation mechanism of the muscle-propelled vehicle according to a fourth embodiment of the present invention;

FIG. 7b is a front view of the embodiment shown in FIG. 7a;

FIG. 7c is a side view of a motion transformation mechanism of the muscle-propelled vehicle according to a fifth embodiment of the present invention, in its first configuration;

FIG. 7d is a perspective view of the motion transformation mechanism shown in FIG. 7c, in its second configuration;

FIG. 7e is a perspective view of the motion transformation mechanism shown in FIG. 7c, in its third configuration;

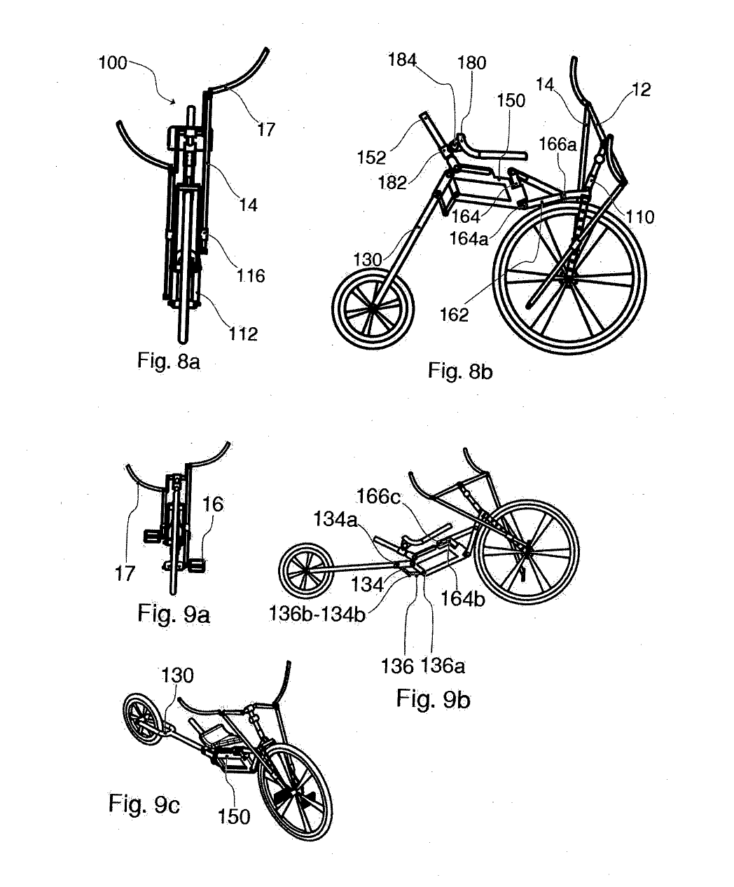

FIG. 8a is a front view of a first embodiment of the muscle-propelled vehicle according to the present invention in its first possible configuration;

FIG. 8b is a side view of the vehicle shown in FIG. 8a;

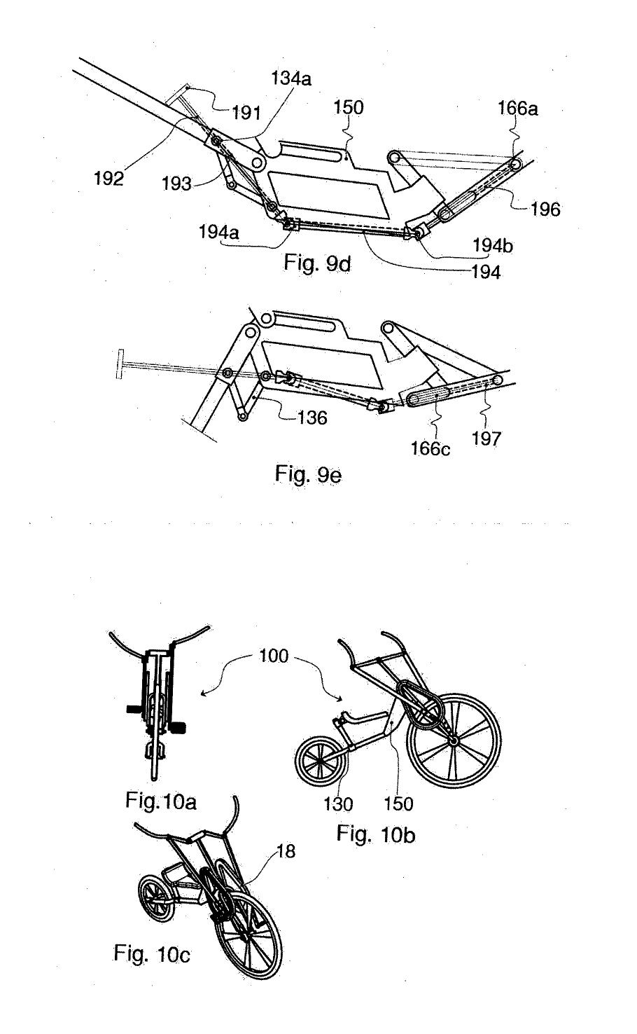

FIG. 9a is a front view of the vehicle shown in FIG. 8a in its second possible configuration;

FIG. 9b is a side view of the vehicle shown in FIG. 9a;

FIG. 9c is a perspective view of the vehicle shown in FIG. 9a;

FIG. 9d is a side view of a mechanism for synchronous regulation of frame portions shown in FIGS. 8a to 9c, in its first configuration;

FIG. 9e is a side view of the mechanism for synchronous regulation shown in FIG. 9d, in its second configuration;

FIG. 10a is a front view of a second embodiment of the muscle-propelled vehicle according to the present invention;

FIG. 10b is a side view of the vehicle shown in FIG. 10a;

FIG. 10c is a perspective view of the vehicle shown in FIG. 10a;

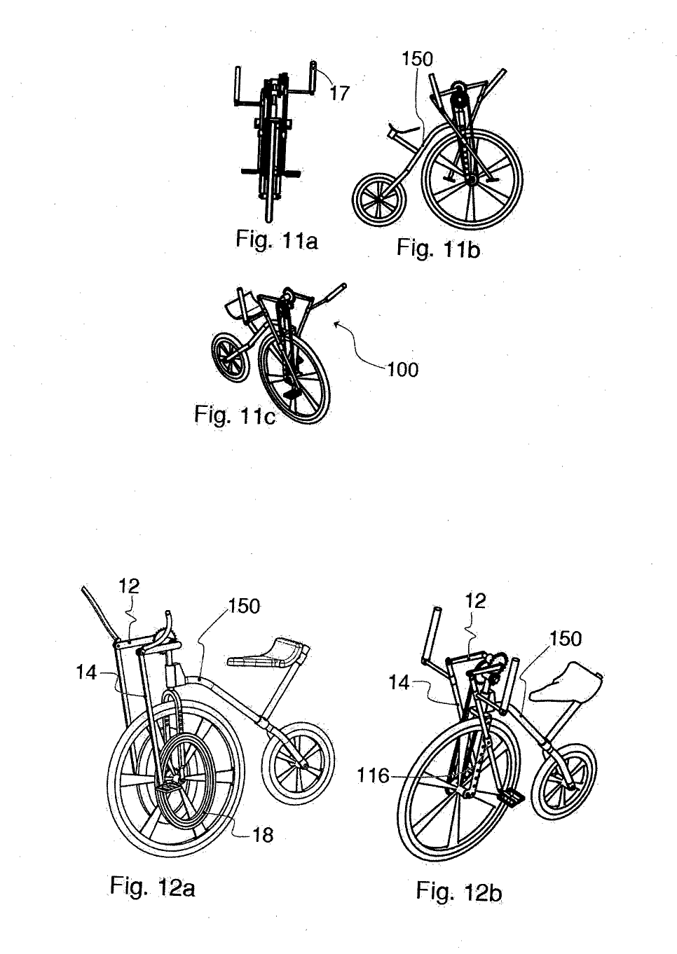

FIG. 11a is a front view of a third embodiment of the muscle-propelled vehicle according to the present invention;

FIG. 11b is a side view of the vehicle shown in FIG. 11a;

FIG. 11c is a perspective view of the vehicle shown in FIG. 11a;

FIG. 12a is a perspective view of a fourth embodiment of the muscle-propelled vehicle of the present invention;

FIG. 12b is a perspective view of an alternative embodiment of the embodiment shown in FIG. 12a;

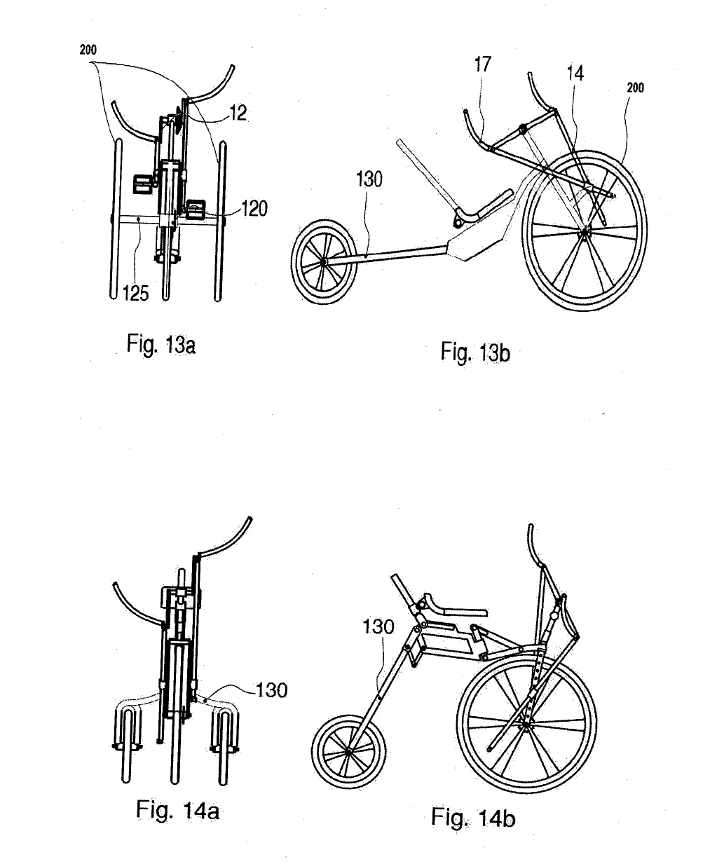

FIG. 13a is a front view of a fifth embodiment of the muscle-propelled vehicle according to the present invention;

FIG. 13b is a side view of the embodiment shown in FIG. 13a;

FIG. 14a is a front view of a sixth embodiment of the muscle-propelled vehicle according to the present invention;

FIG. 14b is a side view of the embodiment shown in FIG. 14a; and

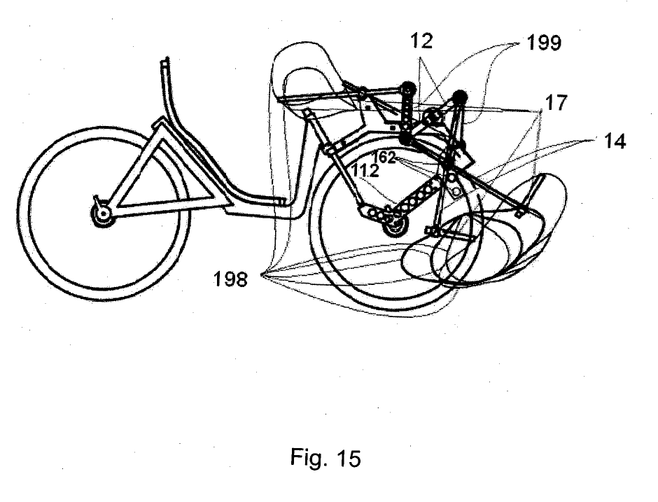

FIG. 15 is a view of an actual embodiment of the vehicle of the present invention.

With reference now to FIGS. 1a and 1b, there are shown a portion of the mechanism 10 of motion transformation and a portion of the transmission mechanism 20 of the self-propelled vehicle 100 according to a first embodiment of the present invention.

The motion transformation mechanism 10 comprises a pair of cranks 12, rotatably fixed at their first end 12a, to opposite ends of a hub 2 and are mutually offset at 180°. At the other end 12b said cranks are each directly hinged to a first end 14a of a connecting rod 14, which in turn is provided at the other end 14b with a pedal 16, adapted to receive the thrust of a user's foot. An elongated element 15 has a first end 15a integral with a sleeve 15′ or similar member adapted to receive in a slidable and securable way the body of the connecting rod 14, while at the other end 15b element 15 is hinged to a bar 17 provided with a hand grip for the user. On the hub 2 a gear 22 is fixed, comprising a first gear wheel 22a coaxial with said hub 2, meshing with a second gear wheel 22b, which in turn drives a coaxial shaft 24 on which a group 26 of crown wheels is keyed, said group being a component of the gearshift system (not shown); said gear wheels 22a and 22b are adapted to achieve the rotation of the limbs in the same direction of the driving direction, more particularly the lower limbs or both pair of limbs, when connected with sleeves such as the component 116 that can be seen in the following figures.

With reference now to FIGS. 2a and 2b, additional components of the motion transformation mechanism 10 are described and illustrated, while for sake of clarity the transmission mechanism 20 is omitted; more particularly a guide member 18 is shown, comprising a closed splined profile, namely a channel or groove 18a made along the entire profile of guide 18. In FIGS. 2a and 2b the front portion of vehicle 100 is also shown, namely fork 110 comprising right and left stems 112. Each stem has a plurality of holes 114 into which pins (not shown) of guide 18 are engaged, protruding from the opposite side of channel 18a for fixing a guide on each stem 112. In this embodiment each connecting rod 14 has a pin (not shown) that ca be inserted into one of a plurality of holes 14c made on said connecting rod, said pin being engaged and slidably constrained in the groove 18a of guide 18. Said holes 14c may also be used for securing, possibly in a rotatable way, pedal 16. Unlike the motion transformation mechanism illustrated in FIGS. 1a and 1b, the motion transformation mechanism now described has hand grip bars 17 directly hinged at the joint between crank 12 and connecting rod 14, without interposition of the elongated element 15. Moreover each grip bar 17 is slidable in a sleeve 116 or similar member rotatably fixed to a body portion 118 of a handlebar and/or stem 112, extending upwards from fork 100. Briefly, in FIGS. 2c and 2d an embodiment of the motion transformation mechanism 10 is shown, alternative to the just described one, wherein use of guide profiles 18 is provided also for bars 17, clearly as substitute for the above described sleeve 116. Although the same profile 18 is illustrated for guiding both the connecting rods 14 and the bars 17, this should not be construed as limiting the possible embodiment of the invention but only for illustrative purposes; indeed the lower and upper profiles 18 may have different geometrical characteristics, as to shape and/or dimensions.

In FIGS. 3a and 3b still another embodiment of the motion transformation mechanism 10 of the vehicle of the present invention is shown, wherein the arm propulsion portion, namely the pair of grip bars 17, is constrained with connecting rods 14 in a similar way to that shown in FIGS. 1a and 1b. The leg propulsion portion, namely the pair of connecting rods 14, is however connected to stems 112 of fork 110 with a system derived from the arm propulsion portion illustrated in FIGS. 2a and 2b. Indeed, instead of guides 18, a sleeve 116 is rotatably fixed to each stem, also at one of the plurality of holes 114, so that in this way each connecting rod 14 may slide and rotate, still remaining constrained to the corresponding sleeve. For completeness of illustration, also the motion transmission mechanism 20 is shown, wherein a chain 27 transmits motion from one of the crown gears of group 26 to a pinion 28 rotatably integral and coaxially fastened to the hub of the front wheel.

FIGS. 3c to 3f show a first (FIGS. 3c and 3d) and a second (FIGS. 3e and 3f) assembling configuration of an additional gear 23 of the motion transmission mechanism, comprising a pair of toothed profiles 23a and 23b meshing with one another. In the figures said profiles 23a and 23b have an elliptical development and are assembled in such a way that profile 23a is rotatably integral with the hub of cranks 12 at one of the ellipse foci, i.e. the hub axis passes said focus, while profile 23b has a rotation axis coincident at one of its foci with the axis of an intermediate circular crown gear 29a. This intermediate crown gear actuates through an intermediate chain 29, an intermediate circular pinion 29b which is in turn coaxial to the crown group 26. This now described transmission mechanism allows to achieve a gear ratio of gear 23 variable according to the relative angle of rotation of the two profiles 23a and 23b; this variability may be suitably used according to its configuration, to dampen the acceleration peaks (consequently of the torque transmitted to the front wheel) linked to the specific pedal path, so as to achieve a driving torque approximately constant during the entire pedalling action. The desired synchronization between variability of gear ratio and pedal acceleration profile, will depend either from the kind of embodiment chosen for the motion transformation mechanism or from dimensional factors of the motion transmission mechanism. In the second assembling configuration of this mechanism (FIGS. 3e and 3f), the profiles 23a and 23b have rotation axes no more passing through the foci of said profiles, but through their centers, this condition allowing to achieve a different variability of the gear ratio in comparison with the variability of the previously illustrated first configuration. It is apparent that transmission mechanisms may be provided, even if they are not described in detail, in which profiles 23a and 23b have forms different from the elliptical one, that however may be adopted to conform to pedal paths possible with other embodiments of the motion transformation mechanism according to the present invention.

FIGS. 4a and 4b show a motion transformation mechanism 10 according to an embodiment which is alternative to the embodiment shown in the preceding figures: more particularly two spacing members 30 have a C shape, wherein an elongated part 32 is made integral with orthogonal wings 34. A first wing 34 is fixed to stem 112 of fork 110 while on the second wing 34 inside the C profile, sleeve 116 is mounted for sliding and rotating the corresponding connecting rod 14.

FIGS. 5a to 5d show particular profiles of the splined guide 18, that can have an elliptical (FIG. 5a), triangular (FIG. 5d) or mixed (FIGS. 5b and 5c) form, where in the mixed form straight lengths are connected by curvilinear lengths having suitable bending radii. The illustrated profiles fall within the preferred ones but they should not be construed as limiting the possible embodiments; any suitable profile may be provided when required by particular applications of the vehicle. For instance, the motion transformation mechanism of the muscle-propelled vehicle may be used in applications of physical exercise, where particular profiles may impose a desired motion to the user's limbs. FIG. 5e shows the section of the guide profile, whose C form allows insertion of a pin member of the connecting rod 14, allowing it to slide along channel 18a but at the same time preventing it to come out accidentally during use of the vehicle 100. In this case too, the C form illustrated in FIG. 5e should not be construed as limiting possible embodiments, but merely as illustrative example. Other kinds of section may be easily provided either as a function of the intended application or on the basis of the specific geometry of the pin member adopted for the connecting rod. For instance more complex sections may be provided to hinder entrance of dirt and its interference with the sliding movement of the pin, more particularly for an off-road use of the vehicle.

FIGS. 6a and 6b show an alternative embodiment of the motion transformation mechanism 10 of the muscle-propelled vehicle according to the present invention, in which a second fork member 110 is fixed to the hub of the front wheel in an angular adjustable manner. In this way the steering axis and therefore the regulation of the forecarriage (whose mechanism will be described in detail hereinafter) will be uncoupled from the longitudinal axis of the motion transformation mechanism. In detail and for clarity of description, fork 110 shown inclined in FIG. 6a is the one rotatably fixed to the steering tube, while fork 110 has the function of supporting the mechanisms of motion transformation and motion transmission. Stems 112 again provided with a plurality of holes 114, allow an adjustable fastening for instance of sleeves 116 of connecting rods 14. This embodiment therefore allows further modifications and configurations of motion of the connecting rods, and consequently of the path provided for propulsion of the lower limbs. FIGS. 6c to 6e show a disk element 160 provided with a plurality of holes 162; this disk element may be fixed to one of holes 114 of stem 112, thus allowing a broad choice of positioning sleeve 116 even outside the stem axis, i.e. a regulation that otherwise would be impossible to be effected. More particularly FIGS. 6c and 6d show two different positions, with different inclinations, of fork 110 on which the motion transformation mechanism 10 is mounted, such a regulation being essential for instance for adjusting the distance between pedals and seat of the vehicle as a function of the rider's height.

FIGS. 7a and 7b show a further embodiment of the motion transformation mechanism 10 of the vehicle according to the present invention, alternative to the double fork embodiment illustrated in FIGS. 6a and 6b. In addition to the latter, an approximately triangular support and regulation member 40 may be connected to each stem 112 of fork 110 supporting the motion transformation and transmission mechanisms. More particularly, regulation member 40 has a vertex part 42 from which two parts 44 extend in a radial direction, and an arc shaped or anyway curvilinear part 46 that connects the straight ends of said parts 44 opposite to the vertex part 42. Said regulation member 40 is fixed at its vertex part 42 through a pin (not shown) to one of the plurality of holes 114 of a stem 112. A guide member 18, as those hereinbefore described, may then be fixed to the regulation member 40, by fastening a first point to the vertex part 42 and a second point in a position within the curvilinear part 46; in this way it is possible to define an inclination of guide member 18 relative to fork 110 of the vehicle, thus relative to the rotation axis of crank 12, again affecting the path of movement of the connecting rod.

FIGS. 7c to 7e show alternative configurations according to a fifth embodiment of the motion transformation mechanism 10 of the vehicle of the present invention. In respect of the previously described embodiments and differently therefrom, in FIGS. 7c to 7e a constraint member for the connecting rod 14 is added, more particularly an elongated connection member 170, hinged to the hub of the vehicle front wheel and to the end 14b of the connecting rod 14. In this way the motion transformation mechanism 10 is comparable with an articulated quadrilateral comprising crank 12, connecting rod 14 and member 170 that has the function of second crank or rocker arm according to the dimensions of the other elements and their position on stem 112. For instance in FIG. 7c the motion transformation mechanism 10 has crank 14 and member 170 of the same length and defining a relative null angle, so that the articulated quadrilateral becomes a four-bar linkage, where member 170 also operates as a crank with a 360° rotation.

Moreover the two right and left linkages are arranged in such a way, as it is conventional, that the cranks 12 are in phase opposition, i.e. forming a relative angle of 180°. On the contrary in FIG. 7d, the same motion transformation mechanism 10 is reconfigurated in respect of that shown in FIG. 7c, so as to have crank 12 and member 170 connected in phase opposition, but the right and left crank 12 parallel, i.e. with a relative angle of 0°. In this way the articulated quadrilateral becomes a reverse four-bar linkage and more particularly the typical pedalling movement is transformed into a movement comparable with rowing, in which the lower and upper limbs pass in a synchronous way from a crouched position, corresponding to the position of connecting rods 14 and bars 17 shown in FIG. 7d, to a stretched position corresponding to a rotation of cranks 12 (or members 170) of 180°. Finally FIG. 7e shows a motion transformation mechanism 10 provided with a member 170 of a length greater than crank 14, and this choice imposes a swinging movement of the connection member 170, like a common rocker arm.

The muscle-propelled vehicle 100 according to its first embodiment is entirely shown in FIGS. 8a and 8b in a first configuration indicated as “closed” and in FIGS. 9a to 9c in its second configuration indicated as “open”. The terms “closed” and “open” are specifically referred to the possibility of changing the orientation of the front fork 110 and the rear fork 130 relative to the rigid portion 150 of the frame, namely the portion on which the rider's sitting element 180 is fixed. In these figures the vehicle 100 adopts the motion transformation mechanism 10 according to a combination of the previously described and illustrated embodiments. The propulsion of the lower limbs occurs through connecting rods 14 linked to sleeves 116 fixed to stems 112, while propulsion of the upper limbs is assigned to bars or half handlebars 17 hinged at the joint between crank 12 and connecting rod 14. However it is clear that as an alternative to the illustrated transformation mechanism, the vehicle 100 may use anyone of the already described embodiments of the mechanism or any desired combination thereof.

Turning now to the rigid portion or body 150 of the vehicle, it is connected in an adjustable way with both the front fork 110 and the rear fork 130. More particularly the connection between body 150 and front fork 110 is assigned to an arc with three hinges, in which a first rod 162 is fixed to the fork 110 and extends to the body 150. At the free end of said first rod 162, an end 164a of a second rod 164 is hinged, said second rod 164 being in turn fixed to the body portion 150 of the frame. The opposite end 164b of rod 164 is sliding along a third rod 166 having in turn an end 166a hinged on said first rod 162 at a position to the fork 110. Therefore the sliding movement of end 164b for instance in a groove 166c made in the body of rod 166, allows to adjust the angle between rods 162 and 164 that are integral with the frame body 150 and the front fork 100, as already noted. Suitable known systems, such as a screw (not shown) may be adopted to block the position of end 164b in the groove 166c, once the user has selected the desired angle, and therefore the forecarriage of vehicle 100. Alternatively, instead of the sliding coupling between rod 164 and groove 166, it is possible to adopt a telescopic element 166, with hydraulic or pneumatic actuation, or any other similar proper element. The connection between the frame body 150 and the rear fork 130 is instead carried out by a pantograph system, in which an end 132 of fork 130 is hinged at a first point of the frame and two rods 134 and 136 at their first ends 134a and 136a are rotatably connected to the frame body 130 and to a second point of the frame body 150, respectively; the opposite ends 134b and 136b are finally hinged to each other, thus defining the above said pantograph system. Several known means, such as the mentioned screw, may be used at one of the hinges or rotoidal joints used in the pantograph system, to block the relative rotation of rear fork 130 in respect of the frame body 150 at an angle that allows to define the wheel base of the vehicle 100 of the invention, as it can be immediately taken from the figures of the drawings. It is now clear that, acting on the connection mechanisms between frame body 150 and front and rear forks 110 and 130, it is possible to adjust independently both wheel base and forecarriage of vehicle 100 by identifying the most proper configuration for the rider as to handling, pedalling and/or rowing path, and stability of the vehicle. Finally, still referring to FIGS. 8a to 9c, it is to be noted that the sitting element 180 may be adjusted either as to height, by sliding the sleeve 182 on a rod 152 integral with frame 150, or as to inclination, by rotating a rotoidal joint 184 connecting sleeve 182 and seat 180; this adjustment is obviously necessary and useful whenever the attitude (wheel base and forecarriage) of the vehicle 100 is changed by the user.

FIGS. 9d and 9e show a system of universal joints for the simultaneous adjustment of forecarriage and wheel base of vehicle 100 of the present invention, the system acting with suitable couplings on the above mentioned rear pantograph system and front three hinges arc, the latter in the embodiment of FIGS. 9d and 9e having the groove 166c properly oriented downwards for an easy operation of the cardanic system to be described hereinafter. The system comprises a first shaft 192 connected through a first spider 194a to an intermediate shaft 194, in turn connected through a second spider 194b to a second shaft 196, the axes of each of said first, intermediate and second shaft being generally concurrent. More particularly the first shaft 192 is provided with a head 191 at the end opposite to the first spider 194a, and a thread 193 made in an intermediate portion of its body; in a similar way the second shaft 196 has thread 197 provided on an intermediate portion of its body. Said threads 193 and 197 are designed for being coupled, like in a worm screw, with threaded pins 134a and 166a positioned at a hinge of the pantograph system (in the figures of the drawings, the hinge fixed on the rear fork 130) and at a hinge of the three hinges arc (in the figures of the drawings, the hinge in proximity of the front fork 110), respectively. Therefore a rotation of head 191 causes a rotation of screw 193 and pin 134a to open or close the pantograph system, while the screw 197, actuated by the cardanic system, imposes a contemporaneous rotation of pin 166a to open or close the front three hinges arc.

At last, FIG. 15 shows the adoption of extensions 17 also between connecting rods 14 and pedals 17; said extensions 17 being adjustable in side length and inclination, thus modifying the path 198 of pedals 16, and these variations in a particularly advantageous way allow to further modify, through few changes of position of the same elements (also in view of components like holes 162), the paths 198 that can be covered by the leaning limbs, thus exerting a force. FIG. 15 also shows the adoption of extensions 199 of cranks 12, without degree of freedom relative to the cranks, and said extensions 199 are connected to the connecting rods 14 and extensions. Like in this case, it is possible to use extensions 17, and on the basis of the length and angularity, possibly adjustable, of said extensions, and also of the variation of length and angularity of extensions 199, it is possible to change the position of the limbs exerting a pressure on said motion elements, even changing the correlation point in the path of the limbs. It has to be noted that it is also possible to obtain significant variations of the path 198, as a result of a little variation of the inclination of the extensions 199, for instance by providing a recess on a diameter equal to the diameter of cranks 12.

From the foregoing detailed description of the muscle-propelled vehicle 110 according to the present invention it is possible to note that this vehicle fully attains the expected objects, mainly comprising the great reduction of the dimensions in comparison with the vehicles adopting analogous motion transformation mechanisms (connecting rod and crank) with the integration of the propulsion of the rider's upper limbs through the adoption of proper halfhandles connected with the motion transformation mechanism, the high possibility of changing configuration of both the pedalling movement and the attitude of the rider during use of the vehicle, the concurrence of all the four limbs relative to their inclination to the trunk in achieving steering of the vehicle, and finally its compactness when not in use, for instance when stored or transported.

The experts in this field may derive from the foregoing description further possible modifications and variations to the vehicle of the present invention, such as for instance the adoption of special fixed frames (shown in FIGS. 10a to 11c), possibly comprising more front wheels 200 (see FIGS. 13a and 13b). These front wheels 200 are driven by a differential element 120 for transmission of motion to said front wheels (as above described) mounted on axle shafts 125 or on frames with variable wheel base, provided with more rear wheels mounted on a proper rear fork 130 (as shown in FIGS. 14a and 14b). Other configurations of the transmission mechanism are also possible for the propulsion in the rowing mode other than the pedalling mode, i.e. with parallel cranks, valid for all the embodiments in which the connecting rod 14 is constrained with the guide profile 18, with the sleeve 116 (see FIGS. 12a and 12b, respectively) or with the member 170. Said configurations are useful in more leaning attitudes of the user, in which it is easier to perform the path of closing the lower limbs. Use of other transmission system, compatible with the combinations of the embodiments described but not explicitly shown in the figures of the drawings, should anyway be considered as all falling within the scope of protection of the present invention, as defined in the appended claims.

1. A muscle-propelled vehicle (100) comprising a frame (150), at least one rear wheel mounted idle on a rear fork (130) of said frame (150), at least a sitting member (180), at least one front wheel mounted on a front fork (110), in turn mounted to be steering relative to said frame (150), characterized by comprising also a first device (162; 164; 166) for adjusting the relative angle between said frame (150) and said front fork (110) and a second device (134; 136) suitable for adjusting the relative angle between said frame (150) and said rear fork (130), said first and second device being connected by a cardan system (192; 194; 196) and actuated synchronously thereby, thus allowing to adjust height and wheel base through said devices, while maintaining the forecarriage unaltered.

2. The muscle-propelled vehicle (100) according to claim 1, further comprising a transformation mechanism (10) of muscle-propelled motion into a rotary motion, and a transmission mechanism (20) of said rotary motion to said at least one front wheel, wherein said transformation mechanism (10) comprises a pair of cranks (12) rotatably integral with said transmission mechanism (20), wherein said transmission mechanism (20) comprises at least two pairs of connecting rods (14), that are driven by four limbs of a rider taking mutual part in the vehicle (100) movement, said vehicle (100) being steerable by inclining at the same time and with the same sense and angle, all four limbs in the same steering direction, relative to the axis of a seat (180).

3. The muscle-propelled vehicle (100) according to claim 2, wherein said at least two pairs of connecting rods (14) each receive the thrust of the rider on a portion thereof and have a first end (14a) hinged to one of the crank pair and connected to at least a constraint member (18, 116, 170) of said transformation mechanism (10), mounted on said front fork (110) or on stems (112).

4. The muscle-propelled vehicle (100) according to claim 2, wherein said transmission mechanism (20) comprises a crown gear (26) and a pinion (28), said crown gear (26) being integral with said cranks (12) of said transformation mechanism (20) and said pinion (28) is coaxially fixed to the hub of said at least one front wheel or to a differential member (120), the motion being transmitted from said crown gear to said pinion by a chain (27).

5. The muscle-propelled vehicle (100) according to claim 2, wherein the pair of cranks (12) is arranged so that the crank connected to the connecting rod pushed by right foot of the user has any angle between 0° and 180° in respect of the crank connected to the connecting rod pushed by left foot of the user.

6. The muscle-propelled vehicle (100) according to claim 2, wherein said motion transmission mechanism (20) further comprises a gear provided with toothed circular profiles (22a, 22b), adapted to allow movement in the same sense of rotation of the limbs, when a constraint member (116) is provided.

7. The muscle-propelled vehicle (100) according to claim 2, wherein said transmission mechanism (20) further comprises a gear provided with non circular toothed profiles (23a; 23b), preferably elliptical, one (23a) of said profiles being rotatably integral with said cranks (12), the other (23b) of said profiles being integral with said crown gear (26), preferably by interposing an intermediate transmission system (29a; 29; 29b).

8. The muscle-propelled vehicle (100) according to claim 6, wherein said constraint member is a sleeve (116) arranged for slideably receiving at least a portion of main body of said connecting rod (14), said sleeve (116) being rotatably fixed to said front fork (110) or stem (112) thereof.

9. The muscle-propelled vehicle (100) according to claim 6, wherein said constraint member is a grooved (18a) closed profile (18) suitable for slideably receiving a pin member fixed on the corresponding connecting rod (14).

10. The muscle-propelled vehicle (100) according to claim 6, wherein said constraint member is fixed, in adjustable manner, to said front fork (110) by interposing a support member (40, 160).

11. The muscle-propelled vehicle (100) according to claim 2, wherein a pedal (16) fixed in adjustable manner along each said connecting rod (14) receives the propulsion force exerted by the foot of a user.

12. The muscle-propelled vehicle (100) according to claim 2, wherein a handlebar (17) fixed in hinged or slideable manner on each said connecting rod (14) or crank (12) receives the propulsion force exerted by the arm of a user.

13. The muscle-propelled vehicle (100) according to claim 12, wherein said handlebar (17) is hinged at the-end (14a) of the connecting rod (14) connected to said crank (12) and is constrained, by a pin fixed on body portion thereof, so as to slide along a grooved (18a) closed profile (18).

14. The muscle-propelled vehicle (100) according to claim 1, wherein said sitting member (180) is adjustable in rotatable and slideable manner in respect of a portion (152) of said frame (150).

15. (canceled)
